(19) United States
(12) Patent Application Publication
(10) Pub. No.: US 2026/0038939 A1
(43) Pub. Date: Feb. 5, 2026

(54) BATTERY CASE AND ASSEMBLY OF BATTERY CASES

(71) Applicant: SAFRAN ELECTRICAL & POWER, Blagnac (FR)

(72) Inventor: Frédéric PINARD, Moissy-Cramayel (FR)

(73) Assignee: SAFRAN ELECTRICAL & POWER, Blagnac (FR)

(21) Appl. No.: 18/997,942

(22) PCT Filed: Jul. 21, 2023
(86) PCT No.: PCT/FR2023/051140

§ 371 Date: Jan. 23, 2025

(30) Foreign Application Priority Data
Jul. 25, 2022 (FR) FR2207621

(51) Int. Cl. H01M 50/249; H01M 10/42; H01M 10/613; H01M 10/615; H01M 10/625; H01M 10/6557; H01M 10/6568; H01M 50/209; H01M 50/258; H01M 50/264; H01M 50/30; H01M 50/502

(52) U.S. Cl. CPC H01M 50/249; H01M 10/425; H01M 10/613; H01M 10/615; H01M 10/625; H01M 10/6557; H01M 10/6568; H01M 50/209; H01M 50/258; H01M 50/264; H01M 50/30; H01M 50/502; H01M 2010/4271

(57) ABSTRACT

A battery case including an electrochemical cell inside the case. A first face of the battery case includes a first, a second and a third band, which are mutually distinct, the first, the second and the third band being delimited by two parallel straight lines passing entirely through the face of the case. The first face of the battery case includes a fluid inlet opening situated within the first band, a fluid outlet opening situated within the second band, and a first and second opening situated within the third band, the first and the second opening forming an interface with a first and a second pole of the electrochemical cell. The present invention also relates to a connection beam for the battery cases and to an electric battery including the beam and at least two battery cases.

### TECHNICAL FIELD AND PRIOR ART

Climate change is a major concern for many legislative and regulatory bodies around the world. Indeed, various restrictions on carbon emissions have been, are or will be adopted by various states. In particular, an ambitious standard applies both to new types of aircraft but also to those in circulation requiring the implementation of technological solutions in order to bring them into line with the regulations in force. Civil aviation has been mobilising for several years now to make a contribution to the fight against climate change.

Technological research efforts have already made it possible to very significantly improve the environmental performance of aircraft. The Applicant takes into consideration the factors impacting all phases of design and development to obtain components and aeronautical products that are less energy-intensive, more environmentally friendly and the integration and use of which in civil aviation have moderate environmental consequences with the aim of improving the energy efficiency of aircraft.

Consequently, the Applicant is continuously working to reduce the negative climate impact thereof through the use of methods and the exploitation of virtuous development and manufacturing processes that minimise greenhouse gas emissions to the minimum possible in order to reduce the environmental footprint of the activity thereof. This sustained research and development work concerns both new generations of aircraft engines, the lightening of aircraft, particularly through the materials used and lightened on-board equipment, the development of the use of electrical technologies to ensure propulsion, and, essential complements to technological progress, aeronautical biofuels.

To this end, the invention is the result of technological research aiming to very significantly improve the performance of aircraft or cars and, in this sense, contributes to reducing the environmental impact of aircraft.

For example, the main function of a battery in a vehicle is to provide the electrical power and voltage necessary for the established mission profiles and the timing thereof. For this, it contains a plurality of cells, for example Li-ion, as well as the components for the electrical and thermal management thereof. The ageing phenomenon of the cells, even more than the reliability of the other components, will strongly impact the battery maintenance operations.

The technical field of the present invention is the installation of a battery by minimising the maintenance time and ensuring the availability of the battery. For example, in the automotive or aeronautical field, the batteries installed on board are composed of cells electrically grouped within a module, providing a voltage lower than that of the battery. These modules are connected in series or in parallel using electric strands.

All of these modules, as well as the liquid cooling system, are installed in a single battery case, closed with a cover equipped with a gasket, using screws.

Replacing a module requires the entire battery to be shut down due to the removal of the battery cover. This operation also increases the electrical risks related to handling the fastening elements, which can fall into the battery and create a short circuit.

Moreover, in an aeronautical application, the number of modules may be much greater than in a motor vehicle and the need for maintenance and/or replacement of the battery must be able to occur quickly.

### DISCLOSURE OF THE INVENTION

To this end, the invention is the result of technological research aiming to very significantly improve the performance of aircraft or cars and, in this sense, contributes to reducing the environmental impact of aircraft. For this, the invention proposes a battery case comprising an electrochemical cell inside the case. A first face of the battery case comprises a first, a second and a third band, which are mutually distinct, the first, the second and the third band being delimited by two parallel straight lines passing entirely through said face of the case. The first face of the battery case comprises:
a fluid inlet opening situated within the first band,
a fluid outlet opening situated within the second band, and
a first and second opening situated within the third band, the first and the second opening forming an interface with a first and a second pole of the electrochemical cell.

The first face of the battery case may have a rectangular shape. Preferably, the battery case has a rectangular parallelepiped shape, said two parallel straight lines passing through the first face of the battery case from one edge to an opposite edge.

A second face opposite the first face of the battery case may comprise a ventilation opening. The battery case may also comprise a third opening situated within the third band, the third opening forming an interface with an electronic device for managing the cell.

The first or the second band may be situated between the two parallel straight lines. A connection beam for at least one battery case may comprise a first duct, a second duct and a third duct each extending inside the beam in a lengthwise direction of the beam, a first face of the beam extending in the lengthwise direction of the beam and comprising a first, a second (260) and a third (270) band, which are mutually distinct, the first, the second and the third bands being delimited by two parallel straight lines (280) passing entirely through said first face in the lengthwise direction of the beam.

The first face may comprise:
a fluid inlet opening to the first duct situated within the first band,
a fluid outlet opening from the second duct situated within the second band, and
a first and second opening situated within the third band, the first and the second opening forming an interface with an electrical connection situated within the third duct.

The beam may have a rectangular parallelepiped shape, the beam comprising a second face opposite the first face, the second face comprising:
a fluid inlet opening to the first duct,
a fluid outlet opening from the second duct, and
a first and second opening forming an interface with a second electrical connection situated within the third duct, a position of the openings of the first face and the second face being axially symmetrical with respect to an axis perpendicular to the elongation of the beam.

An electric battery may comprise at least two battery cases connected by said connection beam, the electrical connection situated within the third duct being configured to electrically connect the two battery cases in series or in parallel.

The battery may comprise on a start or end face of the beam:
a fluid control opening to the first duct, and/or
a fluid discharge opening to the second duct, and/or
a connector to the electrically connected battery cases.

The beam and battery cases may be mounted on a plate, the plate comprising rails for guiding the battery case to the beam.

The rails may comprise a material for reducing friction.

### BRIEF DESCRIPTION OF THE DRAWINGS

The present invention will be better understood based on the following description and the appended drawings wherein:

FIG. 1a shows a battery case comprising one cell or more than one electrochemical cell inside the case,

FIG. 1b shows a first face of the case,

FIG. 2 shows a first view of a connection beam,

FIG. 3 shows a second view of the connection beam,

FIG. 4 shows a three-dimensional view of a portion of the beam,

FIG. 5 shows the beam mounted on a plate,

FIG. 6 shows a battery comprising a plurality of battery cases comprising an electrochemical cell.

### DETAILED DISCLOSURE OF PARTICULAR EMBODIMENTS

Particular embodiments will be described below.

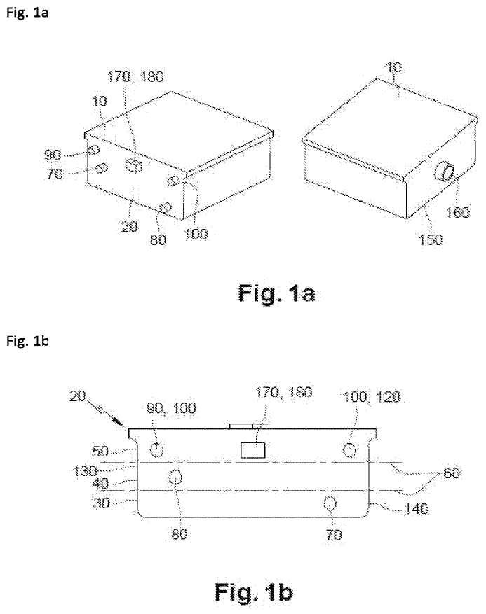

FIG. 1a shows a battery case (10) comprising an electrochemical cell inside the case. The inside of the battery case is not shown in FIG. 1a. The electrochemical cell may, for example, be a Li-ion, Ni-Cd cell or a cell of another chemical. In other words, said battery case is a battery module, comprising an outer package and the electrochemical cell. The expressions “module” and “case” are used equivalently and designate a chemical energy source with a package and a controller for managing the energy source. Preferably, the battery case also comprises a sealed cooling circuit for thermally managing the electrochemical cell. This may concern thermal management for cooling or for heating the cell. Said circuit will mainly be used to cool the cells, but it may also be used to heat them, for example in extreme cold. Despite the name “cooling circuit”, this therefore concerns a circuit provided for cooling and/or heating. The battery case may be sealed outside the openings described below.

A first face (20) of the battery case comprises a fluid inlet opening (70) and a fluid outlet opening (80) for a cooling fluid. The first face of the battery case also comprises a first (90) and second (100) opening forming an interface with a first (110) and a second (120) pole of the electrochemical cell situated within the case. The first (90) and the second (100) opening are thus electrical power interfaces, which will produce the electrochemical cell(s).

As described above, the electrochemical cell may comprise a controller or device for managing the cell. In this case, a third opening (170) is provided on the first face to establish a connection to the device for managing the cell. A second face of the battery case (150) may comprise a ventilation opening (160), as shown in FIG. 1a. The ventilation opening may be configured to make it possible to discharge gas in the case of a thermal runaway of the electrochemical cell. Advantageously, said ventilation opening is provided on a face opposite those of the electrical connections. In the case of a rackable battery case, the face comprising the ventilation opening thus remains accessible.

Thus, said battery case may be a closed and sealed battery case, comprising Li-ion cells or cells of another chemistry and also electrical and electronic components necessary for managing the cell. The battery case may also comprise the fluid or liquid cooling system, which is embedded in the case.

FIG. 1b shows the first face of the case. The same features are designated by the same reference signs already introduced.

As indicated by horizontal lines in FIG. 1b, the first face may be separated into three bands, which are mutually distinct. Said bands serve to better describe the distribution of the openings on the first face of the case.

A first (30), a second (40) and a third band (50), which are mutually distinct, are delimited by two parallel straight lines (60) passing entirely through said first face of the case. The second band is situated between the two parallel lines. The first band and the third band are defined by the portion of the first surface that is outside the two parallel lines.

The fluid inlet opening (70) is situated within the first band and the fluid outlet opening (80) is situated within the second band. The first (90) and the second (100) opening form the interface with the first (110) and the second (120) pole of the electrochemical cell and situated within the third band. Such a distribution or segregation of the openings is particularly advantageous for defining on the surface of the battery case a portion serving for cooling and a portion serving for electrical connections. An interface for connecting one or more battery cases can thus be easily installed.

A third opening (170) may be situated within the third band. This third opening forms an interface with an electronic device (180) for managing the cell, situated inside the case, or in other words, with the electrical and electronic components necessary for managing the cell.

As described above, the first or the second band may be situated between the two parallel straight lines. In other words, the third band, comprising the electrical connection openings, is delimited on one side by an edge of the case. Thus, the electrical connection openings are close to this edge of the case, which facilitates access for performing maintenance. In the case of a battery case placed on a horizontal plane, having the electrical connections above the liquid connections also makes it possible to avoid contamination by possible liquid leaks, which could fall by gravity.

Advantageously, as shown in FIGS. 1a and 1b, the first face of the battery case may have a rectangular shape. It is also possible that the battery case has a rectangular parallelepiped or cube shape. A plurality of battery cases may thus be assembled side by side by minimising an unfilled spacing between the cases. As will be described later, FIG. 5 shows such an assembly of battery cases having a rectangular parallelepiped shape. The battery case shown in FIG. 1b has a first face of rectangular shape. In this case, said two parallel straight lines passing through the first face of the battery case from one edge (130) of the first face to an opposite edge (140) of the first face. FIG. 1b thus shows the first band at the bottom on the rectangular face, the third band at the top and the second band between the two parallel lines.

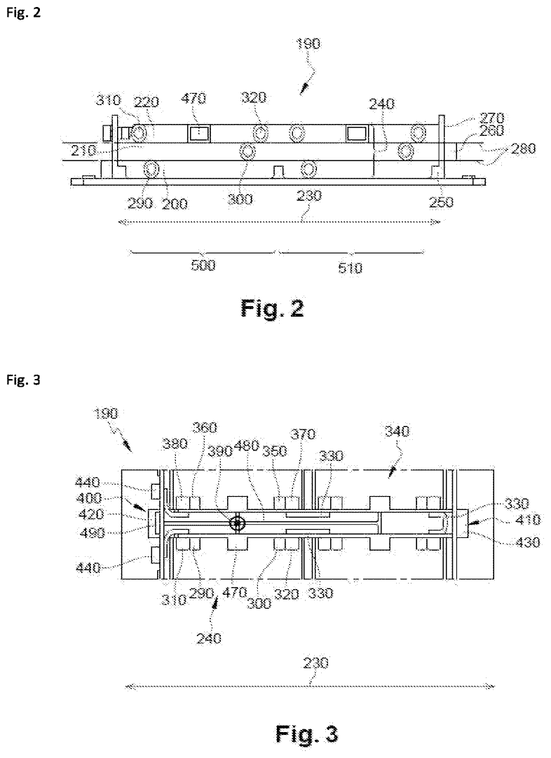

FIG. 2 shows a connection beam (190) configured to provide a connection interface adapted to the battery case with the electrochemical cell described above. The same features are designated by the same reference signs already introduced.

One or more battery cases as described above may be connected to the connection beam. The connection beam can thus connect or assemble a plurality of battery cases (also called modules) to form a battery from a plurality of electrochemical cells. To form an interface adapted to the case, the beam has openings for the cooling fluid and openings forming an electrical or electronic interface. FIG. 2 shows a first interface (500) and a second interface (510) for connecting a first and a second battery case next to one another. The openings forming the interface are distributed over the beam to correspond to the openings of the case. As shown in FIG. 2, the beam extends in a lengthwise direction (230) of the beam. A first face (240) of the beam extends in the lengthwise direction of the beam. This is the face shown in FIG. 2. To form the interface with the case, the first face of the beam comprises a fluid inlet opening (290), a fluid outlet opening (300), and a first (310) and second (320) opening to form an interface with an electrical connection (330) inside the beam, described below. Said openings are distributed on the first face of the beam to form an interface with the case. Thus, the beam comprises, as described for the case, a first (250), a second (260) and a third (270) band, which are mutually distinct. The first, the second and the third band are delimited by two parallel straight lines (280) passing entirely through said first face in the lengthwise direction of the beam. Advantageously, the beam may have a rectangular parallelepiped shape, as already described for the case.

The beam also has a start face (400) and an end face (410). The beam extends in a lengthwise direction of the beam (230) between the start face and the end face.

The fluid inlet opening is situated within the first band (250), one fluid outlet opening is situated within the second band (260), and the first (310) and the second (320) opening are situated within the third band. As already described for the case, said distribution makes it possible to easily distinguish between an electrical portion and a portion serving for cooling. As described below, the first and the second opening may form an electrical connection.

The first or the second band of the beam may be situated between the two parallel straight lines. In other words, the third band, comprising the electrical connection openings, is delimited on one side by an edge of the beam. Thus, the electrical connection openings are close to this edge of the beam, which facilitates access for performing maintenance. Said edge of the beam may comprise a hatch for accessing the inside of the beam for maintenance of the electrical connections or of an electrical connection, described below.

The function of the beam is to be able to supply and recover a cooling fluid to one or more battery cases and to recover electrical power from one or more cases. The beam may also be a central beam of an aircraft or car structure. In this case, a first function of the beam is to ensure a stability of the structure, the function of supplying and recovering the fluid is an additional function. Thus, the beam comprises a first duct (200), a second duct (210) and a third duct (220) each extending inside the beam in the lengthwise direction (230) of the beam. For example, the beam may be an extruded structure comprising the three ducts. Said fluid inlet opening makes it possible to exchange with the first duct (290), said fluid outlet opening makes it possible to exchange with the second duct (300). Said first (310) and second (320) opening form an interface with the electrical connection (330), situated within the third duct.

A beam of rectangular parallelepiped shape, as shown in FIG. 3, has a second face (340) opposite the first face. The same features are designated by the same reference signs already introduced.

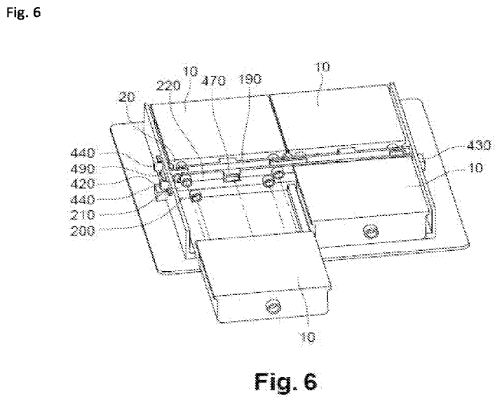

Advantageously, this second face can also form an interface for a battery case as described above. Thus, FIG. 3 shows four interfaces, two placed side by side and two others facing one another. The possibility of assembling two or even more battery cases comprising an electrochemical cell around a central beam (in other words, around a midline), the battery cases being able to be situated on one face and an opposite face of the beam, makes it possible to balance the centres of gravity of the cases. This balancing is particularly advantageous for an application in an aircraft or in a car. As described for the first face, the opposite second face also comprises a fluid inlet opening (350) to the first duct. The second face also comprises a fluid outlet opening (360) from the second duct and a first (370) and second (380) opening forming an interface with a second electrical connection within the third duct. As shown in FIG. 6, described later, the battery cases (10) can thus be situated on either side of the beam, the beam being situated between the two cases.

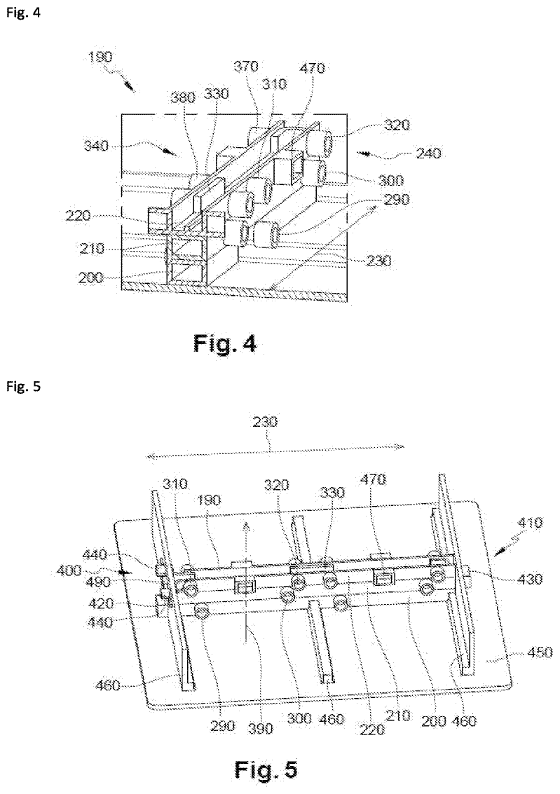

As shown in FIGS. 3, 4 and 5, a position of the openings on the first face and on the second face has an axial symmetry with respect to an axis (390) perpendicular to the elongation of the beam. In other words, the fluid inlet opening to the first duct situated on the first face of the beam is “symmetrical with respect to the axis of symmetry (390)” of the fluid inlet opening to the first duct situated on the second face (340) of the beam. The same applies to the fluid outlet openings (300, 360) and the first and second openings (310, 320, 370, 380) situated on the first and the second face of the beam.

As a consequence of said symmetry of the openings, the same battery case can be connected either to the first face or to the second face of the beam. As shown in FIG. 6, the battery case (10) configured to be connected to a position of the first face of the beam can easily change position to be connected to the second face of the beam. It is thus possible to manufacture a plurality of identical battery cases without first determining the position thereof in an assembly using said beam. Furthermore, the duct distributes the fluid to the same battery cases (10) in “parallel”, as opposed to mounting “in series”, which makes it possible to limit the pressure drops between battery cases (10). The same applies to the discharge duct, which recovers the return of the liquid in parallel.

It is also possible to provide on the first face of the beam a plurality of interfaces configured to receive the same case. Each interface on the first face may have a symmetrical interface, as described above, on the second face. The beam thus makes it possible to connect around a central line of the beam a plurality of cases. Thus, an electric battery comprising a plurality of said battery cases (or modules) can be assembled by the beam. The beam makes it possible to control and discharge a thermal management or cooling fluid to the cases. At the same time, the beam makes it possible to recover electrical power from the modules.

As described above, the third duct of the beam comprises an electrical connection (330) that can be contacted through the corresponding openings (310, 320, 370, 380) provided on the first and/or the second face of the beam. An electric battery can thus be assembled by electrically connecting two or more similar battery cases to the beam. By two similar battery cases we understand two battery cases comprising the same distribution of openings on the first face thereof for connecting to the beam. This may also concern identical battery cases. As described above, each battery case of the battery can be exchanged with each other case. Advantageously, maintenance of the battery is thus greatly facilitated. For example, a defective electrochemical cell can easily be exchanged by another case, independent of the position of the battery case on the connection beam.

To form the battery, the electrical connection situated within the third duct may be configured to electrically connect the two battery cases in series or in parallel. As shown in FIG. 3, for a connection in series, the electrical connection situated in the third duct of the beam connects adjacent openings of two cases. The openings may be situated on the same face of the beam (as shown in the middle of FIG. 3) or situated on opposite faces (as shown on the right in FIG. 3, connection in “U” shape).

The connection beam may also comprise a management bus (480). The management bus is situated within the third duct (220) of the beam so as not to cross the path of the electrical connector. For example, as shown in FIG. 3, the management bus may be situated in the middle of the third duct while the electrical connection is situated on the wall.

The management bus joins a management opening (470) situated on the first and/or on the second face of the beam, for example between the first and the second opening. In this way, when the battery case is connected to the beam, the cell management device (180) is connected to the management bus while the third opening (170) of the battery case is connected to the management opening.

The start face and/or the end face of the beam may comprise a control opening (420) and a discharge opening (430) for the thermal management or cooling fluid. This concerns a fluid distribution opening. The control opening provides access to the second duct and the discharge opening provides access to the first duct. The notions of control, discharge, fluid inlet and outlet are exchangeable and depend only on a choice of a direction of flow of the cooling fluid. The start face and/or the end face of the beam thus make it possible to provide and recover the thermal management fluid, which can travel through fluid inlet and outlet openings on the first and/or second face of the beam of the connected battery cases.

Advantageously, the fluid outlet or the discharge opening (430) is situated opposite the fluid inlet or the control opening. In this way, balancing of the heat exchanges between cases is ensured. It is also possible to provide the inlet and the outlet on the same face of the beam.

The start face and/or the end face of the beam may also comprise a management connector (490) forming an interface with the management bus. Thus, through the management connector and by passing through the management bus (480), it is possible to contact the management device of the electrochemical cell within the case. The start face and/or the end face of the beam may also comprise a connector (440) to the battery cases that are electrically connected. Said connector forms an interface with the electrical connection (330) situated at the third duct of the beam. The electrical power provided by the battery cases connected in series or in parallel can thus be recovered.

FIG. 6 shows a battery comprising a plurality of battery cases (10) connected by the connection beam. FIG. 5 shows the same connection beam without the cases. The connection beam comprises a plurality of interfaces, each interface being configured to receive a battery case with the electrochemical cell thereof.

Each battery case comprises, as described above, the fluid inlet and outlet opening, the openings making it possible to access the poles of the electrochemical cell and the opening making it possible to access the management module of the cell. Each interface of the beam comprises the corresponding openings, as described above, for providing and recovering the cooling fluid, for connecting the poles of the cell to the electrical connection within the beam and for connecting the management device of the cell to the management bus.

As described above, the battery cases are identical with respect to the position of the openings on the first face of the case. Each face of the beam comprises a plurality of interfaces for a plurality of cases. The interfaces situated on the same side of the beam are identical in order to make it possible for each battery case to be placed on each interface. Each interface on the first face of the beam has a symmetrical interface, as described above, on the opposite second face, so as to make it possible for the same battery case to be connected to either the first or the second face. In other words, each battery case can be connected to each interface of the connection beam.

As shown in FIG. 6, a plurality of battery cases are connected to the beam to form a battery. The control opening on the start face of the beam makes it possible to pass the cooling fluid through the first duct within the beam to the inside of each connected battery case. After having passed through the battery case to cool the electrochemical cell, the fluid is recovered by the second duct within the beam and discharged to the discharge opening, situated on the end face of the beam.

The poles of the electrochemical cells situated in the battery cases are connected in series or in parallel by the electrical connection situated at the third duct. Advantageously, the third duct makes it possible to access the electrical connections and the management bus through an opening or a hatch extending over a length of the beam. Thus, the third duct may advantageously be situated on an upper side of the beam. For example, when the battery is installed in a vehicle, access is thus facilitated through said hatch. The electrical power of the battery cases connected in series or in parallel can be recovered by the connector situated on the start face of the beam.

The start face of the beam also comprises the management connector for accessing the cell management devices by passing through the management bus. The complete battery can thus be managed through the management connector, which makes it possible to address each electrochemical cell in each case.

FIGS. 5 and 6 show the connection beam fastened on a plate (450). The battery may comprise the beam and the battery cases mounted on said plate. Rails (460) are also mounted on the plate and configured to guide the battery case to the beam. The rails also fasten the battery cases to prevent a lateral movement, in a lengthwise direction of the beam.

If there is a need to work on a case, for example on the electrochemical cell or on the management device of the cell, it is sufficient to move the battery case in order to disconnect it from the connection beam. Disconnecting a battery case does not impact the other battery cases (or modules) of the battery. To facilitate the movement of a battery case, the rails may comprise a material for reducing friction, for example Teflon. The removed battery case can be easily replaced with another case, because all battery cases comprise the same connection interface. Thus, maintenance time is reduced and the battery can remain operational while a defective battery case (or module) is repaired.

The connections between the openings of the battery case and the openings on the beam can be protected by stops. During the placement of the case, an impact can thus be damped.

In the case of a thermal runaway occurring within a case, these stops also protect the connections from a thrust force exerted by the gases leaving through the ventilation opening, directly opposite the connections. The need for structural reinforcement related to this phenomenon is thereby limited.

1. A battery case comprising an electrochemical cell inside the case, a first face of the battery case comprising a first, a second and a third band, which are mutually distinct, the first, the second and the third band being delimited by two parallel straight lines passing entirely through said face of the case, the first face of the battery case comprising:
a fluid inlet opening situated within the first band,
a fluid outlet opening situated within the second band, and
a first and second opening situated within the third band, the first and second opening forming an interface with a first and a second pole of the electrochemical cell.

2. The battery case according to claim 1, wherein the first face of the battery case has a rectangular shape, wherein the battery case has a rectangular parallelepiped shape, said two parallel straight lines passing through the first face of the battery case from one edge to an opposite edge.

3. The battery case according to claim 1, wherein a second face opposite the first face of the battery case comprises a ventilation opening and/or wherein the battery case comprises a third opening situated within the third band, the third opening forming an interface with an electronic device for managing the cell.

4. The battery case according to claim 1, wherein the first or the second band is situated between the two parallel straight lines.

5. A connection beam for at least one battery case according to claim 1, the beam comprising a first duct, a second duct and a third duct each extending inside the beam in a lengthwise direction of the beam,
a first face of the beam extending in the lengthwise direction of the beam and comprising a first, a second and a third band, which are mutually distinct, the first, the second and the third band being delimited by two parallel straight lines passing entirely through said first face in the lengthwise direction of the beam, the first face comprising:
a fluid inlet opening to the first duct situated within the first band,
a fluid outlet opening from the second duct situated within the second band, and
a first and second opening situated within the third band, the first and the second opening forming an interface with an electrical connection situated within the third duct.

6. The connection beam according to claim 5, having a rectangular parallelepiped shape, the beam comprising a second face opposite the first face, the second face comprising:
a fluid inlet opening to the first duct,
a fluid outlet opening from the second duct, and
a first and second opening forming an interface with a second electrical connection situated within the third duct, a position of the openings of the first face and the second face being axially symmetrical with respect to an axis perpendicular to the elongation of the beam.

7. An electric battery comprising at least two similar battery cases according to claim 1, the electrical connection situated within the third duct being configured to electrically connect the two battery cases in series or in parallel.

8. The battery according to claim 7, comprising on a start face or end face of the beam:
a fluid control opening to the first duct, and/or
a fluid discharge opening to the second duct, and/or a connector to the electrically connected battery cases.

9. The battery according to claim 7, wherein the beam and battery cases are mounted on a plate, the plate comprising rails for guiding the battery case to the beam.

10. The battery according to claim 9, wherein the rails comprise a material for reducing friction.
